(19) United States
(12) Patent Application Publication
(10) Pub. No.: US 2009/0251298 A1
(43) Pub. Date: Oct. 8, 2009

(54) METHOD AND APPARATUS FOR OFFICIATING AN ATHLETIC CONTEST

(75) Inventor: DAVID DAKERS, VICTORIA (CA)

Correspondence Address: JOHN RUSSELL UREN, 1590 BELLEVUE AVENUE, SUITE 202, WEST VANCOUVER, BC, V7V1A7, CA

(73) Assignee: RG PROPERTIES LTD., VANCOUVER (CA)

(21) Appl. No.: 12/363,890

(22) Filed: Feb. 2, 2009

Related U.S. Application Data
(63) Continuation-in-part of application No. 12/175,628, filed on Jul. 18, 2008.
(60) Provisional application No. 60/951,164, filed on Jul. 20, 2007.

(51) Int. Cl. G07C 1/00

(52) U.S. Cl. 340/323 R

(57) ABSTRACT

Apparatus and method for controlling and officiating an athletic contest such as a hockey game. The official utilises a control unit removably mounted on his arm. A spring mounted button allows the official to signal time starting and time stoppage events. A keyboard allows the entry of further data relating to the time starting and time stoppage events such as a score or penalty. A scanner allows the official to scan a bar code or RFID chip associated with and carried by each player to obtain information of that player. All data and time starting and time stopping events are transmitted wirelessly by the control unit to a receiver-processor located remotely from the control unit.

### CROSS-REFERENCES TO RELATED APPLICATIONS

This application is a continuation-in-part of application Ser. No. 12/175,628 filed Jul. 20, 2007, now pending, which application claims priority from U.S. Provisional Application Ser. No. 60/951,164 filed Jul. 20, 2007.

### INTRODUCTION

This invention relates to a method and apparatus for officiating an athletic contest and, more particularly, to a method and apparatus for officiating and conducting a hockey game.

### BACKGROUND OF THE INVENTION

Hockey games and other athletic contests typically use a number of individuals during the event such as timekeepers, penalty box personnel, goal judges and the like. In a hockey game, for example, when a whistle is blown by a referee, the timekeeper will manually stop the clock and when the puck is dropped following the game stoppage, the timekeeper will manually start the clock. If a penalty is called, the referee will blow a whistle, the timekeeper will stop the clock, the referee will skate to the penalty box and advise the penalty box personnel of the nature of the infraction, the identity of the player who committed the infraction and the length of time the player will be penalized and therefore off the ice. Thereafter the game again commences with the manual participation of the timekeeper and the penalty box personnel. If a goal is scored, the referee will blow the whistle; the timekeeper will stop the clock, and the referee will skate to the scorekeeper's position and advise the scorekeeper of the identity of the goal scorer and any players assisting on the goal. The goal recorder will enter this information on a recording device or manually on a data entry device. The information is translated into a machine readable code and is subsequently displayed on the clock which is viewed by spectators attending the hockey game.

Clearly, the procedure is time consuming and inefficient in the use of personnel. The costs of personnel are high and even if the personnel are performing on a voluntary basis, it is difficult to obtain appropriate personnel assistance particularly where minor or non-professional hockey games are being played.

### SUMMARY OF THE INVENTION

According to the invention, there is provided apparatus for officiating an athletic contest comprising a control unit operable to be carried by an individual officiating said athletic contest, said apparatus including an input device operable by said individual to signal time stoppage and time starting events, a wireless transmitter to transmit said time stoppage and time starting signals wirelessly to a remotely controlled receiver and a display operable to show said time stoppage and time starting events.

According to a further aspect of the invention, there is provided apparatus for controlling a hockey game comprising a control unit carried by an official which control unit generates signals corresponding to time starting and time stoppage events, said control unit allowing the entry of data relating to said time starting and time stoppage events, said control unit allowing wireless transmission of said signals and said data to a location remote from said control unit, said control unit having a scanner allowing said official to scan one of a plurality of RFID chips associated with each of the players in said hockey game to obtain an identification number, said control unit allowing the wireless transmission of said player identification number to said server.

According to still yet a further aspect of the invention, there is provided a method for controlling and officiating an athletic contest comprising the steps of providing an official with a control unit which allows for the entry of a signal for a time stoppage and a time starting event, said control unit further allowing the entry of data by said official relating to said time stoppage and time starting event, scanning a respective RFID chip uniquely associated with each of the players in said athletic contest to obtain a unique identification number of said player, wirelessly transmitting said signals of said time starting and time stoppage events and said player identification number to a receiver located remotely from said control unit.

According to still yet a further aspect of the invention, there is provided a method for controlling and officiating a hockey game comprising providing an individual with a wireless transmitting control unit having RFID chip scanning and event timing stop and start capabilities, said capabilities being initiated by said individual, the data relating to said RFID chip scanning and timing stop and start capabilities being wirelessly transmitted to a processing unit located remotely from said control unit.

According to yet a further aspect of the invention, there is provided apparatus for facilitating the identification of a player in an athletic contest prior to the athletic contest in which the player may be participating, said apparatus comprising a scanner to scan an RFID chip or a bar code associated with said player before said contest thereby to obtain a unique identification number associated with said player and a retrieving unit being associated with said scanner to retrieve a photograph associated with said unique identification number of said player.

According to still yet a further aspect of the invention, there is provided a method for facilitating the identification of a player in an athletic contest prior to the athletic contest in which said player may be participating, said method comprising scanning an RFID chip carrying a unique player identification number associated with said player, associating said player identification number with a photograph of said player and displaying said photograph so that said player may be identified by said photograph.

According to still yet a further aspect of the invention, there is provided a method of obtaining a lineup of desired players for an imaginary athletic contest with a number of players playing in said athletic contest, each of said players having playing statistics, said method comprising selecting a player having a unique identification code associated with said player, retrieving the playing statistics associated with said player and allowing the selected ones of said players to form said lineup in said athletic contest.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic plan view of an ice surface of an ice rink illustrating twelve (12) players and two referees with a public scoreboard located adjacent the ice surface;

FIG. 2 is a diagrammatic side view of a hockey helmet worn by each player with a unique bar code pertaining to that player fastened to the helmet;

FIG. 3 is a diagrammatic isometric view of a portable and wireless transmitting device in the form of a control unit which is carried by the official in charge of the hockey game and which allows for his further input;

FIGS. 4A and 4B are diagrammatic isometric views of the body harnesses used to hold the control unit worn and operated by the official;

FIG. 5 is a diagrammatic isometric view of an alternative harness used for holding the control unit in a further embodiment of the invention;

FIG. 6 is a diagrammatic view of the various operating components associated with the control unit which operating components are used on and adjacent to the ice rink; and

FIG. 7 is a flow chart diagrammatically illustrating the data flow upon the initiation of action by an official.

### DESCRIPTION OF SPECIFIC EMBODIMENT

Referring now to the drawings, an ice hockey game is typically played at an arena with an ice surface generally illustrated at 100. An ice hockey team typically has six (6) players 101 on each team, including one (1) goalie in each goal 104. Typically, two (2) officials 102, 103 are used in a hockey game with one (1) of such officials 102 generally being responsible for calling offside players and icing calls. The other of the two (2) officials 103 is generally responsible for stopping and starting the clock, calling infractions or penalties on miscreant players and assigning goals and assists to the players after a score or goal.

Each of the players 101 will be wearing a helmet 111 (FIG. 2). Each helmet 111 has a unique bar code 110 conveniently affixed to it. The bar code 110 may carry any desired information relating to the player and the playing location. For example, the bar code 110 of a player 101 would conveniently carry his team identification, his playing number, his name and his position although additional historical information such as penalty or scoring could also be carried.

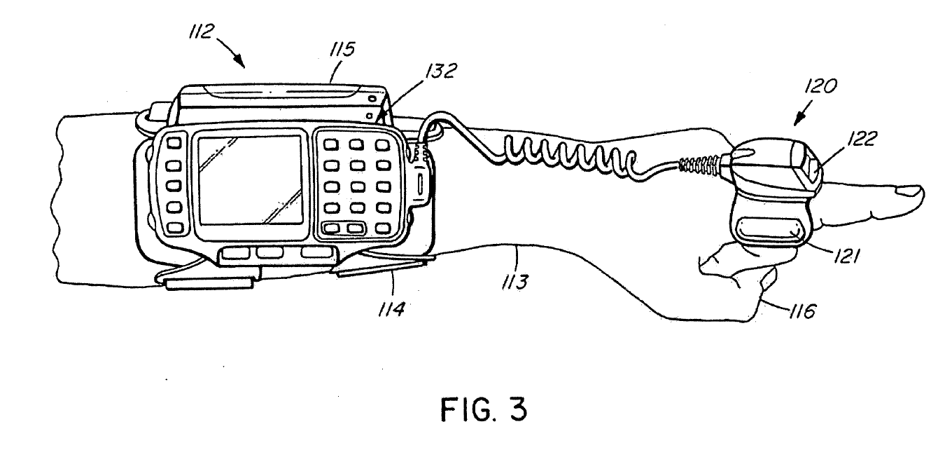

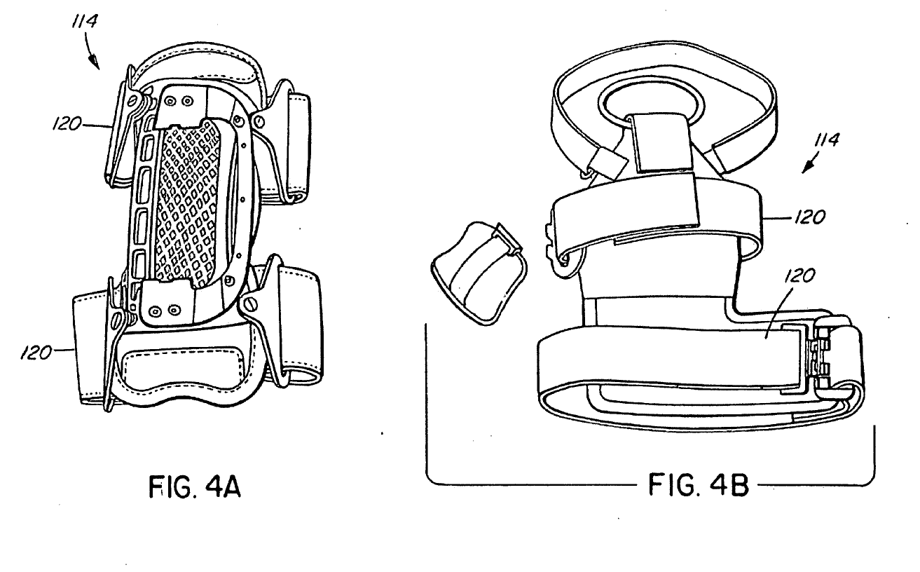

A control unit generally illustrated at 112 is carried by the official 103 as is illustrated in greater detail in FIG. 3. The control unit 112 will typically be carried on the arm 113 of the official 103 with the use of the arm harness generally illustrated at 114 in FIGS. 4A and 4B. The control unit 112 is securely mounted to the arm harness 114 which, in turn, utilises straps 120 such that the control unit 112 and harness 114 is securely mounted to the arm 113 of the official 103.

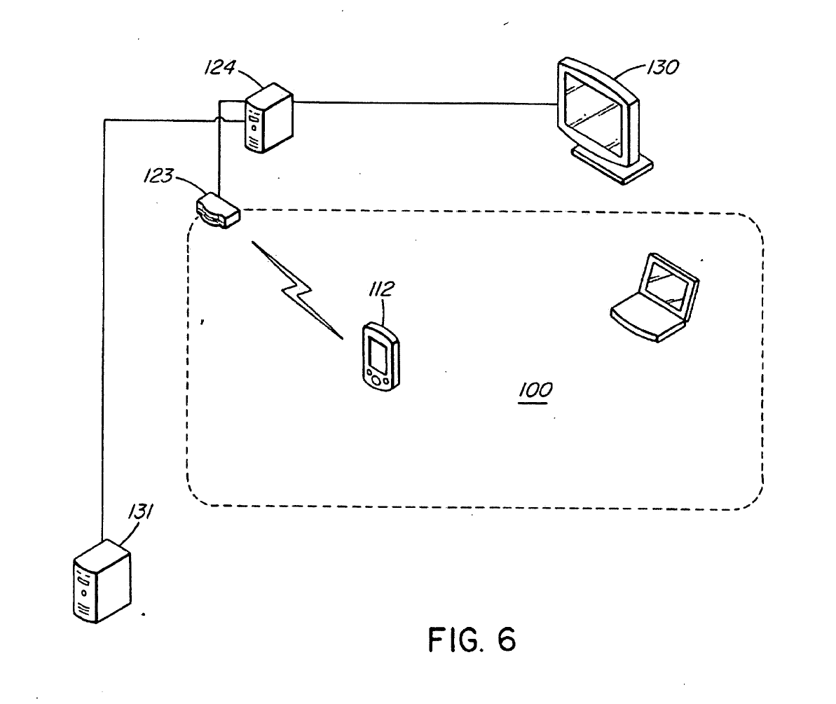

The control unit 112 also includes an operating input device generally illustrated at 120 which is flexibly connected to the main housing 115 of the control unit 112. The input device 120 is hardwired to the main housing 115 and will contain a first spring mounted button 121 and a bar code scanner 122. By initially pressing the spring mounted button 121 with his thumb 116, the official 103 may input a stop clock signal. The stop clock signal is wirelessly transmitted from the control unit 115 to a wireless access point receiver 123 (FIG. 6) as will be explained in greater detail. By pressing the spring mounted button 121 with his thumb 116 a second time, the official 103 will input a start clock signal which is similarly wirelessly transmitted to the wireless access point receiver 123.

The bar code scanner 122 (FIG. 3) has the capability of scanning the bar code 110 (FIG. 2) affixed to the helmet 111 of the player 101. The bar code scanner 122 is again operated by the official 103. The information from the bar code scanner 122 is transmitted wirelessly to the access point 123. The scan of the bar code 110 affixed to the players helmet 111 may conveniently be done by the scanner 122 when the official 103 calls a penalty or infraction on the player 101, in the event a player 101 scores a goal or assists on such a goal or before the hockey game begins in order to create a player roster for the game.

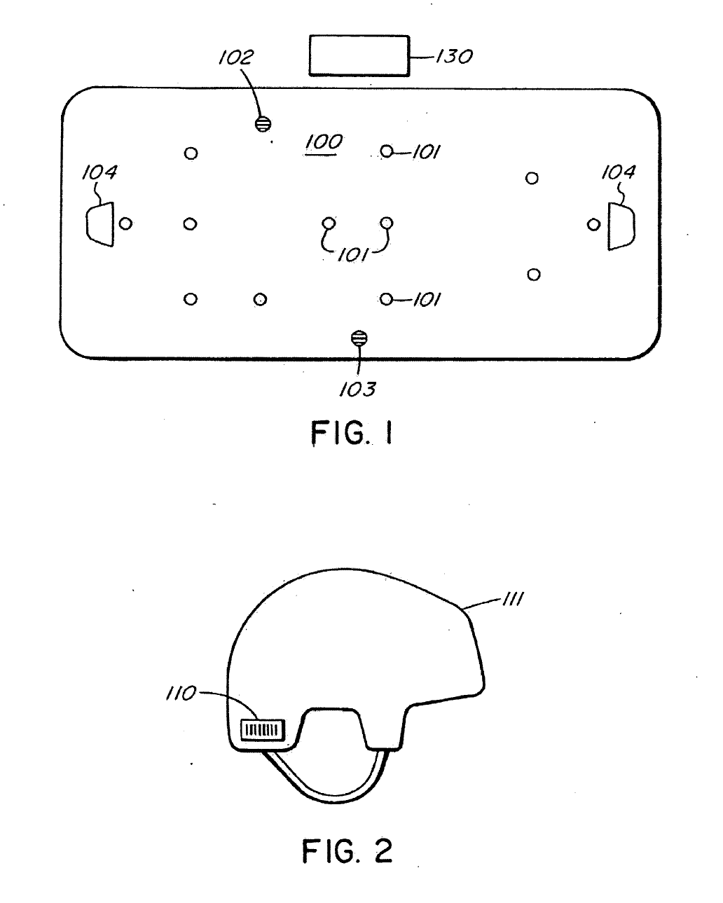

Reference is made to FIG. 6. The control unit 112 worn by the official 103 communicates wirelessly with access point 123 conveniently located adjacent the ice surface 100. The access point 123 communicates, conveniently by hard wiring, with an arena server 124. The term “arena server” is meant to cover a server which typically holds information specific to the area or ice surface 100 on which the hockey game is being played. For example, arena server 124 conveniently provides power and information to the display board 130 (FIGS. 1 and 6). It may also contain information specific to the contest such as ice conditions and historic player data relating to the ice surface on which the game is played.

The arena server 124 is conveniently also connected to a central server 131 which is located remotely from the ice surface or arena 100. The central server 131 is conveniently internet accessible so that information can be timely transmitted from the arena server 124 to the central server 131 either automatically after an interval or in real time. The central server 131 is conveniently located at league headquarters or at some other central data collection point so that a number of arena servers 124 are in communication with the central server 131. Information received by the central server 131 would thereafter be communicated as desired such as to news media and the like.

The arena server 124 is also connected to the scoreboard or display device 130 in the arena 100. The scoreboard 130 carries a time clock (not illustrated) and information on penalties and scoring (not illustrated) so that the information entered by the official 103 through his control unit 112 is immediately publicly displayed to those in attendance at the contest.

### Operation

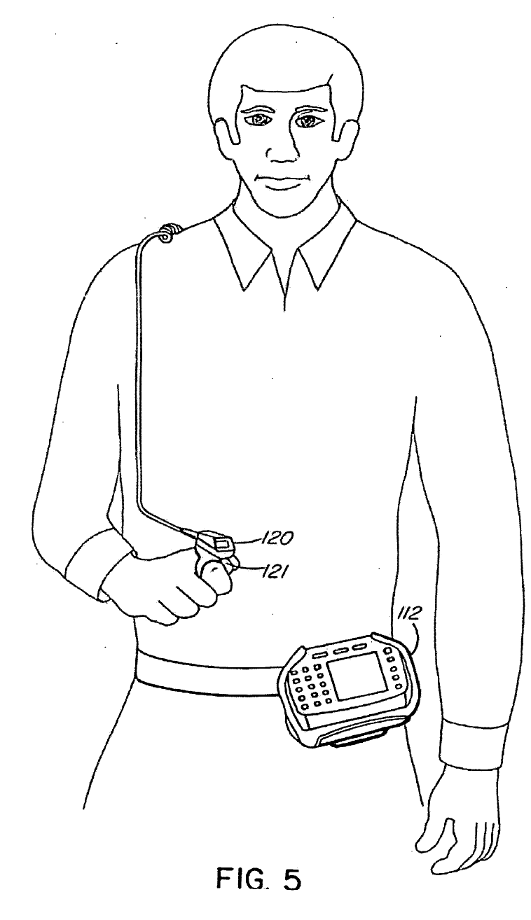

In operation, the official 103 will mount the control unit 112 to the arm harness 114 and use the straps 120 (FIG. 4A) to mount the control unit 112 to his arm 113. The input device 120 will likewise be mounted on the finger of the official 103 as also illustrated in FIG. 5 so that the thumb 116 will properly touch the spring mounted button 121. The official 103 will then test the control unit 112 to ensure proper operation and communication with the wireless access point 123 prior to commencement of the game.

When the official 103 drops the puck to commence operation of the hockey game, his thumb 116 will press the spring mounted button 121. This will initiate a start clock signal passed wirelessly from the control unit 112 to the wireless access point 123 and thence to the arena server 124 which in turn commences operation of the clock (not illustrated) on the display board or scoreboard 130. Play will continue until a play stoppage event occurs such as a penalty, an offside or a score. If, for example, an offside occurs, the official 103 will press the spring mounted button 121 which initiates a stop clock signal passed wirelessly from the control unit 112 to the wireless access point 123 and thence to the area server 124 which in turn stops the clock on the scoreboard 130.

If a penalty is called on a player, the official will initiate a stop play signal as described to terminate running of the clock. The official 103 will also skate to the player 101 on whom the penalty was called, make a data entry on the keyboard 132 of the control unit 112 to specify the type of penalty being called. The time in respect of which the player will be off the ice will be automatically calculated or manually entered but if the official 103 wishes to lengthen or shorten such time, an additional entry on key board 132 will be made. The official 103 sill also scan the bar code 110 of the helmet 111 of the player 101 being penalized.

The information scanned by bar code scanner 122 and as entered by the official 103 is passed from the control unit 112 to the wireless access point 123, thence to the arena server 124 and finally to the scoreboard 130 where it is displayed. The information originating with the official 103 and transmitted by the control unit 112 to the arena server 124 through the wireless access point 123 is also transmitted to the central server 131 for dissemination as desired.

If a scoring play occurs, the official will similarly initiate a stop play signal to terminate running of the clock by pressing spring mounted button 121. He will skate to the player who scored, make an appropriate data entry on the keyboard 132 of the control unit 112 and scan the bar code 110 on the helmet 111 of the scoring player. The information is similarly passed from the control unit 112 wirelessly to the arena server 124 via wireless access point 123. Similarly, a scan may be conducted of the helmets 111 of those players 101 who assisted in the score.

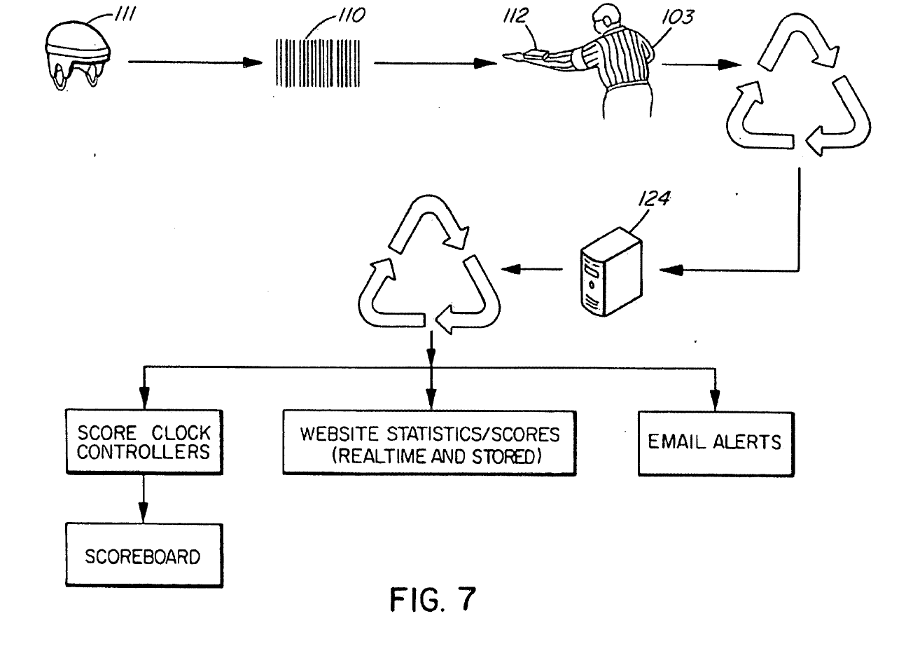

FIG. 7 illustrates diagrammatically the flow of data from a time stoppage event. If a player 101 scores, time is stopped as previously described and his helmet 111 and its attached bar code 110 are scanned to provide the identification of the player 101 and the time of the play stoppage event. The official 103 makes the appropriate entries on the keyboard 132 of the control unit 112 and the information is transmitted via wireless access point 123 to arena server 124. The barcode entry, being specifically attributed to an individual player and team, is passed to a database within server 124. The server 124 then passes the information to a scoreboard 130 or other displaying entities such as website, e-mails, website scoring displays and the like.

While the wireless control unit 112 has been described in association specifically with the game of hockey, it is contemplated that the teachings according to the invention could be used for other sporting events, particularly those events where a specific time duration for the event is provided and where, for example, the number of officials is limited. It is contemplated that basketball and/or soccer could conveniently benefit from the technology according to the invention. Further, while a mounting arrangement on the arm of a user has been described, it may be more convenient to mount the control unit 112 to the waist of an official as illustrated in FIG. 5. In this event, the bar code scanner 120 and spring mounted button 121 will be connected to the control unit 112 with a connection of greater length than the connection illustrated in the FIG. 3 embodiment.

While the control unit 112 has been described as being particularly advantageous for an “on-ice” or “on-field” official, it is also contemplated that the control unit 112 could be held and operated by an appropriately sanctioned bystander or official or volunteer off the ice or field surface. The “on-field” official could signal a time stopping event and if a player scored or was penalized, he could skate to the position of the control unit 112 where appropriate scanning could take place. While the reduction of official personnel would not be as great as anticipated in this embodiment, the “off-field” location could still reduce the personnel required to properly officiate the athletic contest.

In a further embodiment of the invention, it is contemplated that a further technique for providing player identification other than a bar code which may be positioned on the helmet or other part of the uniform of a player would be desirable. Rather than a bar code, a microchip transponder, also known as a permanent radio-frequency identification (RFID) chip, may be used. The unique number associated with the RFID chip is stored in the transponder and may be picked up by a small antenna in the transponder. The scanner held by the official reads the low-frequency radio waves emitted by the transponder and thereby retrieves the player statistics associated with the unique number. More importantly, the unique identification number is preferably transmitted to a scorer or to a receiver positioned remotely from the official. The scorer or receiver may then correlate the number received by the scanner held by the official to a bar code or to player statistical data associated with the identification number. By comparing the number with the bar code, the scorer may obtain all information relating to the player, upgraded if necessary and stored once again to be used as necessary in the future. If a scorer is not present, the player identification number can be compared directly with all information and/or statistics on that particular player and the information may again be retrieved, upgraded if necessary and stored once again. If desired, the information or parts of it may be displayed for spectators or players to see. The RFID chip need not be placed on the helmet. Rather, it could be positioned anywhere on the player. If appropriate, it could be placed in a temporary badge or other holder used only for the purpose of playing a single game when it is then removed.

The advantage with the use of an RFID chip is that the player need not be stationary following the event in order for the scanner held by the official to scan the bar code. Rather, the scanner need only be brought into the vicinity of the transponder associated with the RFID chip for the number of the player and his playing statistics to be obtained. This reduces the restraint placed on the players by the use of the scanner according to the invention immediately following an event which is intended to be noted.

It is further contemplated that other devices besides a bar code and an RFID chip may be used to provide a unique identification of a player. All that is necessary is for the device to provide a unique identification of the player with which the device is associated.

Yet a further embodiment of the invention lies in the use of the bar code or RFID chip to facilitate the identity of a player or the correlation of the statistics or other information associated with the particular player. In this embodiment, the RFID chip or bar code is scanned by a scanner upon player check in to the dressing room in anticipation of the event to be played. The unique identity of the user given by the RFID chip or bar code can be associated with a photograph of the player. After the RFID or bar code is scanned, the photograph of the player can be brought up and compared with the actual individual associated with the RFID chip or bar code. This allows the records associated with the bar code or RFID chip to maintain their integrity and to ensure they are associated only with the actual player in the contest.

In yet a further aspect of the invention, the statistics associated with the unique bar code or RFID chip may be used with appropriate copyright and other proprietary protection being provided to the player. This use contemplates that the individual players may be chosen by contestants in a “virtual lineup” to form an imaginary team and the statistics associated with each individual may be used to give results in such an imaginary athletic contest. After each event, with upgraded or uploaded information, the individual player information is provided to the contestants who formed the virtual lineup to determine if their lineup was more proficient than the lineup of other contestants. As is usual, an aware of some type would be given to the successful contestant.

Many further modifications will readily occur to those skilled in the art to which the invention relates and the specific embodiments herein described should be considered as illustrative of the invention only and not as limiting its scope as defined in accordance with the accompanying claims.

I claim:

1. Apparatus for officiating an athletic contest comprising a control unit operable to be carried by an individual officiating said athletic contest, said apparatus including an input device operable by said individual to signal time stoppage and time starting events, a wireless transmitter to transmit said time stoppage and time starting signals wirelessly to a remotely controlled receiver and a display operable to show said time stoppage and time starting events.

2. Apparatus as in claim 1 and further comprising an RFID chip positioned adjacent or on a player participating in said athletic contest, said RFID chip carrying a unique player identification number associated with said player, said control unit carrying a scanner operable to remotely retrieve said unique player identification number associated with said RFID chip and to transmit said player identification number remotely to a scorer or other receiving unit, said player identification number being associated with the statistics of said player and said scorer or receiving unit being operable to retrieve said statistics of said player upon receipt of said player identification number associated with said RFID chip.

3. Apparatus as in claim 2 wherein said athletic contest is a hockey game with a plurality of players, each of said players carrying a respective RFID chip with each respective RFID chip having a unique player identification number associated with said player.

4. Apparatus as in claim 3 wherein said unique player identification number associated with said player and said data relating to said time stoppage and time starting events is transmitted wirelessly from said control unit to a remote location and is stored and processed at said location or at a further location remote from control unit.

5. Apparatus as in claim 4 wherein said location remote from said control unit is an arena server.

6. Apparatus as in claim 4 wherein said location remote form said control unit is a central server.

7. Apparatus for controlling a hockey game comprising a control unit carried by an official which control unit generates signals corresponding to time starting and time stoppage events, said control unit allowing the entry of data relating to said time starting and time stoppage events, said control unit allowing wireless transmission of said signals and said data to a location remote from said control unit, said control unit having a scanner allowing said official to scan one of a plurality of RFID chips associated with each of the players in said hockey game to obtain an identification number, said control unit allowing the wireless transmission of said player identification number to said server.

8. Method for controlling and officiating an athletic contest comprising the steps of providing an official with a control unit which allows for the entry of a signal for a time stoppage and a time starting event, said control unit further allowing the entry of data by said official relating to said time stoppage and time starting event, scanning a respective RFID chip uniquely associated with each of the players in said athletic contest to obtain a unique identification number of said player, wirelessly transmitting said signals of said time starting and time stoppage events and said player identification number to a receiver located remotely from said control unit.

9. Method as in claim 8 wherein said data relating to said time starting and time stoppage events and said player identification data are processed remotely from said control unit.

10. Method as in claim 9 wherein said signals from said time starting and time stoppage events are used, respectively, to commence and terminate the running of a clock.

11. Method as in claim 10 wherein said data relating to said time starting and time stoppage events and said player identification data are publicly displayed.

12. Method for controlling and officiating a hockey game comprising providing an individual with a wireless transmitting control unit having RFID chip scanning and event timing stop and start capabilities, said capabilities being initiated by said individual, the data relating to said RFID chip scanning and timing stop and start capabilities being wirelessly transmitted to a processing unit located remotely from said control unit.

13. Apparatus for facilitating the identification of a player in an athletic contest prior to the athletic contest in which the player may be participating, said apparatus comprising a scanner to scan an RFID chip or a bar code associated with said player before said contest thereby to obtain a unique identification number associated with said player and a retrieving unit being associated with said scanner to retrieve a photograph associated with said unique identification number of said player.

14. Method for facilitating the identification of a player in an athletic contest prior to the athletic contest in which said player may be participating, said method comprising scanning an RFID chip carrying a unique player identification number associated with said player, associating said player identification number with a photograph of said player and displaying said photograph so that said player may be identified by said photograph.

15. Method of obtaining a lineup of desired players for an imaginary athletic contest with a number of players playing in said athletic contest, each of said players having playing statistics, said method comprising selecting a player having a unique identification code associated with said player, retrieving the playing statistics associated with said player and allowing the selected ones of said players to form said lineup in said athletic contest.
